(19) United States
(12) Patent Application Publication
(10) Pub. No.: US 2006/0029845 A1
(43) Pub. Date: Feb. 9, 2006

(54) Fuel cell system

(76) Inventors: Masaaki Konoto, Kyoto City (JP); Masaya Fujii, Toyonaka City (JP); Kazuhiro Seo, Hirakata City (JP); Masahiro Makino, Ikoma-gun (JP)

Correspondence Address: MCDERMOTT WILL & EMERY LLP, 600 13TH STREET, N.W., WASHINGTON, DC, 20005-3096, US

(21) Appl. No.: 11/193,610

(22) Filed: Aug. 1, 2005

(30) Foreign Application Priority Data
Aug. 6, 2004 (JP) 2004-230410
Mar. 30, 2005 (JP) 2005-097826

(51) Int. Cl. H01M 8/04; H01M 16/00

(52) U.S. Cl. 429/23; 429/9; 320/101

(57) ABSTRACT

A fuel cell system of the invention is built as a system in which a fuel cell stack and an electric storage device are provided in parallel, and includes, in addition to the fuel cell stack and the electric storage device, a fuel feeder and a DC/DC converter. The fuel feeder feeds the fuel cell stack with fuel. The DC/DC converter converts the output voltage of the electric storage device into a predetermined voltage and outputs it. This predetermined voltage is equal to or higher than the output voltage of the fuel cell stack as obtained when it is outputting the maximum output electric power. The fuel cell system of the invention is free from shortening of the lifetime of the fuel cell.

This nonprovisional application claims priority under 35 U.S.C. § 119(a) on Patent Application No. 2004-230410 filed in Japan on Aug. 6, 2004 and Patent Application No. 2005-097826 filed in Japan on Mar. 30, 2005, the entire contents of which are hereby incorporated by reference.

### BACKGROUND OF THE INVENTION

1. Field of the Invention

The present invention relates to a fuel cell system in which a fuel cell and an electric storage device are provided in parallel.

2. Description of Related Art

In recent years, there have been developed various fuel cell systems in which a fuel cell and an electric storage device are provided in parallel (see, for example, Japanese Patent Application Laid-open No. 2004-71260). An example of the configuration of a conventional fuel cell system is shown in FIG. 14.

The fuel cell system shown in FIG. 14 is built as a system in which a fuel cell and an electric storage device are provided in parallel, and comprises a fuel cell stack 1, a fuel feeder 2, a rechargeable battery 3 as an electric storage device, a DC/DC converter 4, and a blocking diode 5. The fuel feeder 2 feeds the fuel cell stack 1 with a predetermined amount of fuel at regular time intervals, and collects from the fuel cell stack 1 the fuel that has remained unused therein. The output end of the fuel cell stack 1 is connected to the anode of the blocking diode 5, and the positive pole of the rechargeable battery 3 is connected to the input end of the DC/DC converter 4. The cathode of the blocking diode 5 and the output end of the DC/DC converter 4 are connected together, and the node between them is connected to a load 6.

As a result of the fuel feeder 2 feeding the fuel cell stack 1 with a predetermined amount of fuel at regular time intervals, the fuel cell stack 1 has current-to-voltage and current-to-power characteristics as shown in FIG. 15. In FIG. 15, the symbols T_{I-V} and T_{I-P} indicates the current-to-voltage and current-to-power characteristic curves, respectively, of the fuel cell stack 1.

As the output current of the fuel cell stack 1 varies, the output voltage thereof varies; specifically, as the output current increases, the output voltage lowers. The value Ipmax of the output current obtained when the output electric power is at its maximum depends on the amount of fuel fed from the fuel feeder 2 to the fuel cell stack 1. In the range of current larger than Ipmax, the fuel cell stack 1 operates unstably. Making the fuel cell stack 1 operate continuously in the range of current larger than Ipmax leads to shortening the lifetime of the fuel cell stack 1. The problem with the conventional fuel cell system is that, depending on the state of the load 6, the fuel cell stack 1 may operate continuously in the range of current larger than Ipmax.

### SUMMARY OF THE INVENTION

An object of the present invention is to provide a fuel cell system that is free from the possibility of shortening the lifetime of a fuel cell.

To achieve the above object, according to one aspect of the present invention, a fuel cell system built as a system in which a fuel cell and an electric storage device are provided in parallel is provided with: the fuel cell; a fuel feeder; the electric storage device; and a DC/DC converter. The fuel feeder feeds the fuel cell with fuel. The DC/DC converter converts the output voltage of the electric storage device into a predetermined voltage and then outputs it. The predetermined voltage is equal to or higher than the output voltage of the fuel cell as obtained when the fuel cell is outputting the maximum output electric power. Used as the electric storage device is, for example, a rechargeable battery or an electric double layer capacitor.

With this configuration, as the consequence of the predetermined voltage being set equal to or higher than the output voltage of the fuel cell as obtained when the fuel cell is outputting the maximum output electric power, the fuel cell never operates in a range of voltage lower than the output voltage of the fuel cell as obtained when the fuel cell is outputting the maximum output electric power. This eliminates the possibility of shortening the lifetime of the fuel cell.

Preferably, the fuel feeder feeds the fuel cell with a predetermined amount of fuel at regular time intervals, and collects, from the fuel cell, the fuel that has remained unused therein. This makes it possible to reuse unused fuel.

Preferably, the fuel feeder operates from electric power derived from the output of the fuel cell system. This eliminates the need to provide a separate power supply for the fuel feeder.

From the viewpoint of enhancing the efficiency of the fuel cell system, preferably, the output end of the fuel cell and the DC/DC converter are directly connected together. With this configuration, no blocking diode is connected to the output side of the fuel cell, and this helps enhance the efficiency of the fuel cell system by the amount of power loss that would occur across a blocking diode.

Preferably, there is additionally provided an on/off control circuit that turns the operation of the DC/DC converter on and off. This on/off control circuit, when the output voltage of the fuel cell is higher than a predetermined value, turns the operation of the DC/DC converter off and, when the output voltage of the fuel cell is not higher than the predetermined value, turns the operation of the DC/DC converter on. Here, the predetermined value is set slightly larger than the value of the previously mentioned predetermined voltage

With this configuration, the DC/DC converter operates only when it feeds electric power to an external load. Thus, when the DC/DC converter feeds no electric power to the external load, the DC/DC converter wastes no electric power. This enhances the efficiency of the fuel cell system.

Preferably, there are additionally provided: a load electric power detector; an output electric power checker; and a supply fuel amount controller. The load electric power detector detects, as a load electric power, the electric power that an external load requires from the fuel cell system. The output electric power checker checks whether or not electric power is being fed from the DC/DC converter to the external load. The supply fuel amount controller receives the result of the detection by the load electric power detector and the result of the checking by the output electric power checker so that, if electric power is being fed from the DC/DC converter to the external load when the load electric power is lower than a threshold value, the supply fuel amount controller controls the fuel feeder to make the fuel feeder feed the fuel cell with fuel.

With this configuration, whenever electric power is being fed from the DC/DC converter to the external load despite the load electric power being lower than the threshold value, the fuel cell is fed with fuel. This helps prevent the fuel cell from running short of fuel.

To achieve the above object, according to another aspect of the present invention, a fuel cell system built as a system in which a fuel cell and an electric storage device are provided in parallel is provided with: the fuel cell; the electric storage device; and a fuel cell current limiter. The fuel cell current limiter controls the output current of the fuel cell at a limit value or below. The limit value is equal to or smaller than the value of the output current of the fuel cell as obtained when the fuel cell is outputting the maximum output electric power in a stably operating state after having been used in the stably operating state for a predetermined duration until the output of the fuel cell exhibits a drop as compared with the output in an initial state. Used as the electric storage device is, for example, a rechargeable battery or an electric double layer capacitor.

As the consequence of the limit value being set equal to or smaller than the value of the output current of the fuel cell as obtained when the fuel cell is outputting the maximum output electric power in a stably operating state, the fuel cell never operates in a range of current larger than the output current of the fuel cell as obtained when the fuel cell is outputting the maximum output electric power in a stably operating state. This eliminates the possibility of shortening the lifetime of the fuel cell. Moreover, as the consequence of the limit value bet set equal to or smaller than the value of the output current of the fuel cell as obtained when the fuel cell is outputting the maximum output electric power in a stably operating state after having been used in the stably operating state for a predetermined duration until the output of the fuel cell exhibits a drop as compared with the output in an initial state, the fuel cell operates in a stable region even after it has been used in the stably operating state for the predetermined duration until the output of the fuel cell exhibits a drop as compared with the output in an initial state.

To achieve the above object, according to another aspect of the present invention, a fuel cell system built as a system in which a fuel cell and an electric storage device are provided in parallel is provided with: the fuel cell; the electric storage device; and a fuel cell voltage limiter. The fuel cell voltage limiter controls the output voltage of the fuel cell at a limit value or above. The limit value is equal to or larger than the value of the output voltage of the fuel cell as obtained when the fuel cell is outputting the maximum output electric power in a stably operating state. Used as the electric storage device is, for example, a rechargeable battery or an electric double layer capacitor.

With this configuration, as the consequence of the limit value being set equal to or larger than the value of the output voltage of the fuel cell as obtained when the fuel cell is outputting the maximum output electric power in a stably operating state, the fuel cell never operates in a range of voltage lower than the output voltage of the fuel cell as obtained when the fuel cell is outputting the maximum output electric power in a stably operating state. This eliminates the possibility of shortening the lifetime of the fuel cell. Moreover, the fuel cell operates in a stable region even after it has been used in the stably operating state for the predetermined duration until the output of the fuel cell exhibits a drop as compared with the output in an initial state.

To achieve the above object, according to another aspect of the present invention, a fuel cell system built as a system in which a fuel cell and an electric storage device are provided in parallel is provided with: the fuel cell; the electric storage device; a fuel cell current limiter; and a fuel cell voltage limiter. The fuel cell current limiter controls the output current of the fuel cell at a first limit value or below. The fuel cell voltage limiter controls an output voltage of the fuel cell at a second limit value or above. The first limit value is equal to or smaller than the value of the output current of the fuel cell as obtained when the fuel cell is outputting the maximum output electric power in a stably operating state after having been used in the stably operating state for a predetermined duration until the output of the fuel cell exhibits a drop as compared with the output in an initial state. The second limit value is equal to or larger than the value of the output voltage of the fuel cell as obtained when the fuel cell is outputting the maximum output electric power in the stably operating state. Used as the electric storage device is, for example, a rechargeable battery or an electric double layer capacitor.

With this configuration, the possibility of shortening the lifetime of the fuel cell is eliminated both before and after the fuel cell has been used in the stably operating state for the predetermined duration until the output of the fuel cell exhibits a drop as compared with the output in an initial state. Moreover, sufficient electric power can be extracted from the fuel cell even in the initial state, and the output electric power of the fuel cell is prevented from lowering greatly even after a long duration of use.

To achieve the above object, according to another aspect of the present invention, a fuel cell system built as a system in which a fuel cell and an electric storage device are provided in parallel is provided with: the fuel cell; the electric storage device; a DC/DC converter; a charge circuit; and a controller. The DC/DC converter converts the output voltage of the electric storage device. The charge circuit charges the electric storage device by using the output of the fuel cell. The controller controls the electric power passed through the DC/DC converter and through the charge circuit in such a way that the fuel cell operates at the maximum output electric power operating point thereof. Used as the electric storage device is, for example, a rechargeable battery or an electric double layer capacitor.

With this configuration, the fuel cell outputs its maximum output electric power all the time. Thus, the fuel cell delivers its optimum performance, and it operates in a stable region all the time.

### BRIEF DESCRIPTION OF THE DRAWINGS

FIG. 1 is a diagram showing an example of the configuration of a fuel cell system embodying the present invention;

FIG. 2 is a diagram showing the relationship between the set output voltage of a DC/DC converter and the output voltage of a fuel cell stack;

FIG. 3 is a diagram showing another example of the configuration of a fuel cell system embodying the present invention;

FIG. 4 is a diagram showing still another example of the configuration of a fuel cell system embodying the present invention;

FIG. 5 is a diagram showing the current-to-voltage and current-to-power characteristics of a fuel cell stack;

FIG. 6 is a diagram showing an example of the configuration of a fuel cell system embodying the present invention, in a case where it is provided with a fuel cell DC/DC converter;

FIG. 7 is a diagram showing the current-to-voltage and current-to-power characteristics of a fuel cell stack;

FIG. 8 is a diagram showing another example of the configuration of a fuel cell system embodying the present invention, in a case where it is provided with a fuel cell DC/DC converter;

FIG. 9 is a diagram showing the current-to-voltage and current-to-power characteristics of a fuel cell stack;

FIG. 10 is a diagram showing still another example of the configuration of a fuel cell system embodying the present invention, in a case where it is provided with a fuel cell DC/DC converter;

FIG. 11 is a diagram showing the current-to-voltage and current-to-power characteristics of a fuel cell stack;

FIG. 12 is a diagram showing a further example of the configuration of a fuel cell system embodying the present invention, in a case where it is provided with a fuel cell DC/DC converter;

FIG. 13 is a diagram showing the current-to-voltage and current-to-power characteristics of a fuel cell stack;

FIG. 14 is a diagram showing an example of the configuration of a conventional fuel cell system; and

FIG. 15 is a diagram showing the current-to-voltage and current-to-power characteristics of a fuel cell stack.

### DETAILED DESCRIPTION OF PREFERRED EMBODIMENTS

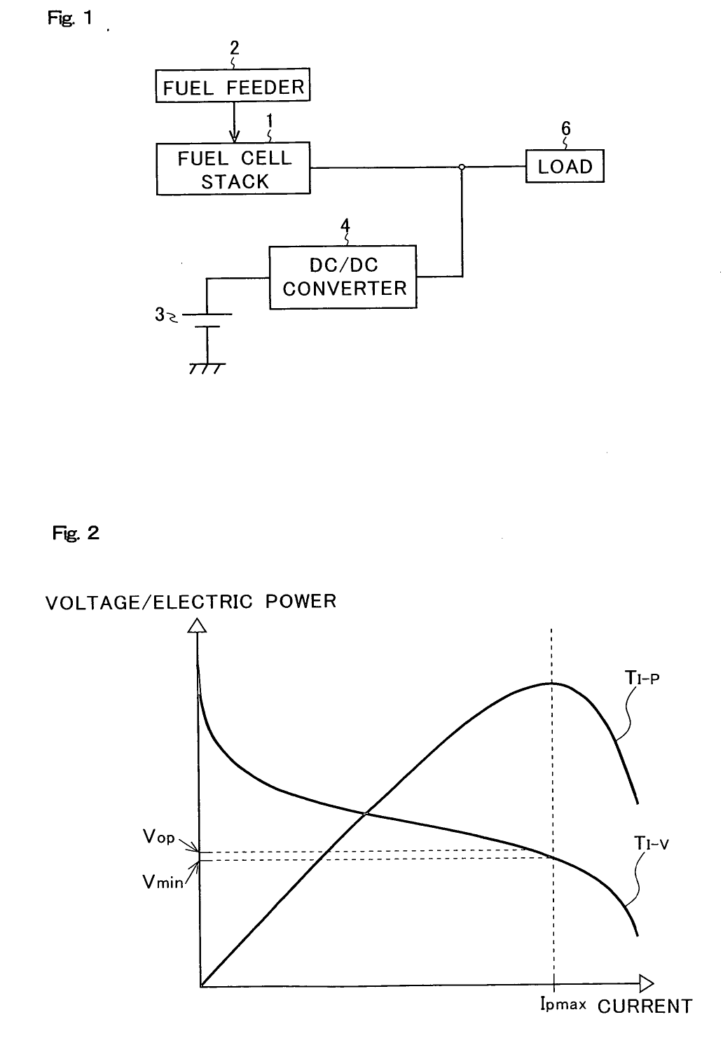

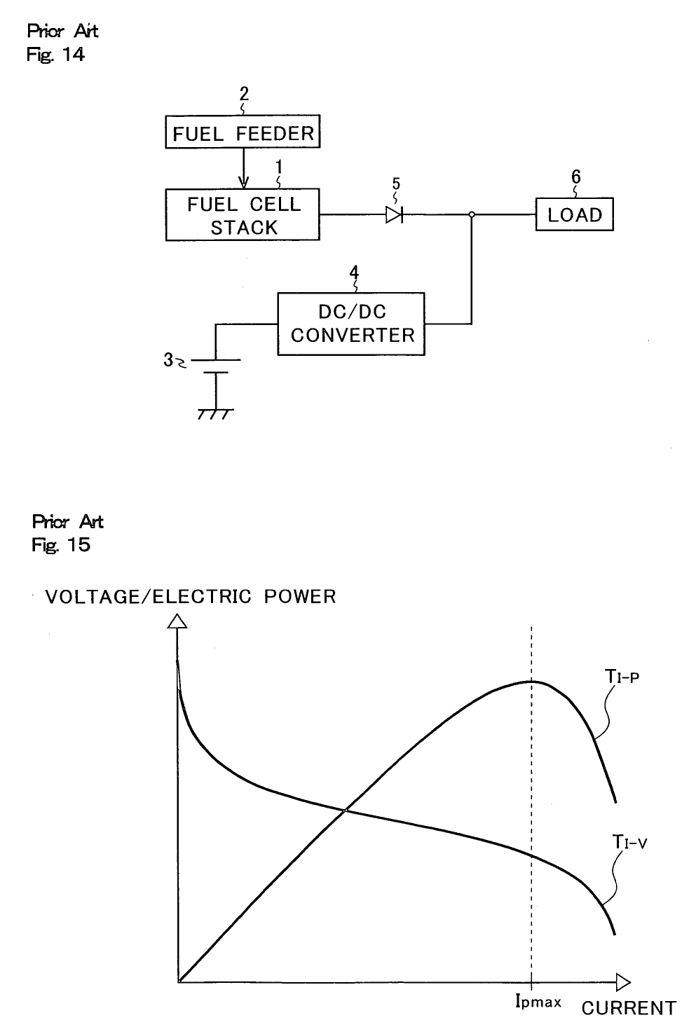

An example of the configuration of a fuel cell system embodying the present invention is shown in FIG. 1. In FIG. 1, such parts as are found also in FIG. 14 are identified with common reference numerals.

The fuel cell system embodying the present invention shown in FIG. 1 is built as a system in which a fuel cell and an electric storage device are provided in parallel, and comprises a fuel cell stack 1, a fuel feeder 2, a rechargeable battery 3 as an electric storage device, and a DC/DC converter 4. The fuel feeder 2 feeds the fuel cell stack 1 with a predetermined amount of fuel at regular time intervals, and collects from the fuel cell stack 1 the fuel that has remained unused therein. The positive pole of the rechargeable battery 3 is connected to the input end of the DC/DC converter 4. The output end of the fuel cell stack 1 and the output end of the DC/DC converter 4 are connected together, and the node between them is connected to a load 6.

The fuel feeder 2 operates from electric power derived from the output of the fuel cell system. That is, although the fuel feeder 2 and the load 6 are shown as separate blocks in FIG. 1 for the sake of convenience, in reality the fuel feeder 2 is part of the load 6.

Now, the relationship between the set output value Vop of the DC/DC converter 4 and the output voltage of the fuel cell stack 1 will be described with reference to FIG. 2. In FIG. 2, such parts as are found also in FIG. 15 are identified with common reference symbols, and no detailed explanation thereof will be repeated. In the currently discussed fuel cell system embodying the present invention, the set output value Vop of the DC/DC converter 4 is set equal to or larger than the value Vmin of the output voltage of the fuel cell stack 1 as obtained when it is outputting the maximum output electric power.

The fuel cell system embodying the present invention shown in FIG. 1 is built as a system in which a fuel cell and an electric storage device are provided in parallel. Thus, here, of the fuel cell stack 1 and the DC/DC converter 4, whichever is outputting a higher output voltage alone feeds electric power to the load 6, except when the fuel cell stack 1 and the DC/DC converter 4 are outputting an equal output voltage, in which case they both feed electric power to the load 6.

With the currently discussed fuel cell system embodying the present invention, when the load 6 is light, the output voltage of the fuel cell stack 1 is higher than the output voltage of the DC/DC converter 4, and the fuel cell stack 1 alone feeds electric power to the load 6. As the load 6 increases and thus the electric power required by the load 6 increases, the output electric power of the fuel cell stack 1 accordingly increases, and thus the output voltage of the fuel cell stack 1 decreases. When the load 6 has increases until the output voltage of the fuel cell stack 1 becomes equal to the set output value Vop of the DC/DC converter 4, both the fuel cell stack 1 and DC/DC converter 4 feed electric power to the load 6. Even when the load 6 further increases and thus the electric power required by the load 6 further increases, the output voltage of the fuel cell stack 1 never becomes lower than the set output value Vop of the DC/DC converter 4, and thus the amount of electric power of which the output electric power of the fuel cell stack 1 is short relative to the electric power required by the load 6 is compensated for by the rechargeable battery 3.

As described above, in the currently discussed fuel cell system embodying the present invention, the set output value Vop of the DC/DC converter 4 is set equal to or larger than the value Vmin of the output voltage of the fuel cell stack 1 as obtained when it is outputting the maximum output electric power. Thus, the fuel cell stack 1 never operates in the range of voltage lower than Vmin (that is, the range of current larger than Ipmax). This eliminates the possibility of shortening the lifetime of the fuel cell stack 1.

From the viewpoint of enhancing the efficiency of a fuel cell system, the fuel cell system embodying the present invention shown in FIG. 1 does away with a blocking diode 5 as is provided in the conventional fuel cell system shown in FIG. 14. The fuel cell stack 1 is free from reversal charge (charging that occurs from a higher-voltage cell to a lower-voltage cell) as can occur in a rechargeable battery, and therefore omitting a blocking diode 5 causes any problem. On the contrary, omitting a blocking diode 5 helps increase the efficiency of the fuel cell system by the amount of power loss that would occur across the blocking diode 5.

As described above, it is preferable that a fuel cell system not be provided with a blocking diode. It is however also possible to apply the present invention to a fuel cell system provided with a blocking diode. In the fuel cell system shown in FIG. 14, which is provided with a blocking diode, when the set output value Vop of the DC/DC converter 4 is set equal to or larger than the value Vmin of the output voltage of the fuel cell stack 1 as obtained when it is outputting the maximum output electric power, the output voltage of the fuel cell stack 1 never becomes lower than the sum of the set output value Vop of the DC/DC converter 4 and the forward voltage Vf of the blocking diode. Thus, the fuel cell stack 1 never operates in the range of voltage lower than Vmin (that is, the range of current larger than Ipmax). This eliminates the possibility of shortening the lifetime of the fuel cell stack 1.

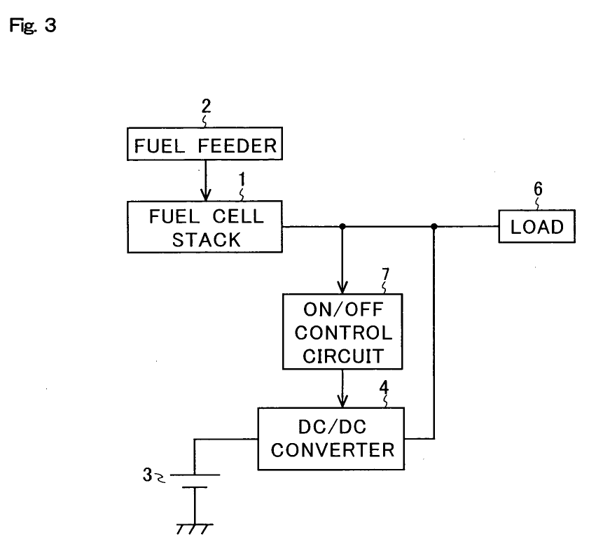

Another example of the configuration of a fuel cell system embodying the present invention is shown in FIG. 3. In FIG. 3, such parts as are found also in FIG. 1 are identified with common reference numerals, and no detailed explanation thereof will be repeated. Moreover, in the fuel cell system shown in FIG. 3, as in the fuel cell system shown in FIG. 1, the set output value Vop of the DC/DC converter 4 is set equal to or larger than the value Vmin of the output voltage of the fuel cell stack 1 as obtained when it is outputting the maximum output electric power.

As compared with the fuel cell system shown in FIG. 1, the fuel cell system shown in FIG. 3 further comprises an on/off control circuit 7. The on/off control circuit 7 detects the output voltage of the fuel cell stack 1, and checks whether or not the output voltage of the fuel cell stack 1 is higher than a predetermined value. If the output voltage of the fuel cell stack 1 is higher than the predetermined value, the on/off control circuit 7 makes the DC/DC converter 4 stop its voltage conversion operation; if the output voltage of the fuel cell stack 1 is not higher than the predetermined value, the on/off control circuit 7 lets the DC/DC converter 4 perform its voltage conversion operation. Here, the predetermined value is set slightly larger than the set output value Vop of the DC/DC converter 4.

With this configuration, the DC/DC converter 4 operates only when it feeds electric power to the load 6. Thus, when the DC/DC converter 4 feeds no electric power to the load 6, the DC/DC converter 4 wastes no electric power. This enhances the efficiency of the fuel cell system.

Even in a fuel cell system provided with a blocking diode, it is possible to additionally provide a on/off control circuit 7 as described above so that, when the DC/DC converter 4 feeds no electric power to the load 6, the DC/DC converter 4 wastes no electric power. This enhances the efficiency of the fuel cell system. From the viewpoint of enhancing the efficiency of the fuel cell system, however, it is preferable to adopt a configuration, as shown in FIG. 3, without a blocking diode.

With the fuel cell system shown in FIG. 3, unless the set output value Vop of the DC/DC converter 4 is set equal to or larger than the value Vmin of the output voltage of the fuel cell stack 1 as obtained when it is outputting the maximum output electric power, it is not possible to achieve the object of the present invention, that is, to eliminate the possibility of shortening the lifetime of a fuel cell. Even then, however, the additional provision of the on/off control circuit 7 does help enhance the efficiency of the fuel cell system. It should therefore be understood that, in any fuel cell system, not limited to one configured as shown in FIG. 3, that is built as a system in which a fuel cell and an electric storage device are provided in parallel, additionally providing an on/off control circuit 7 helps enhance the efficiency of the fuel cell system.

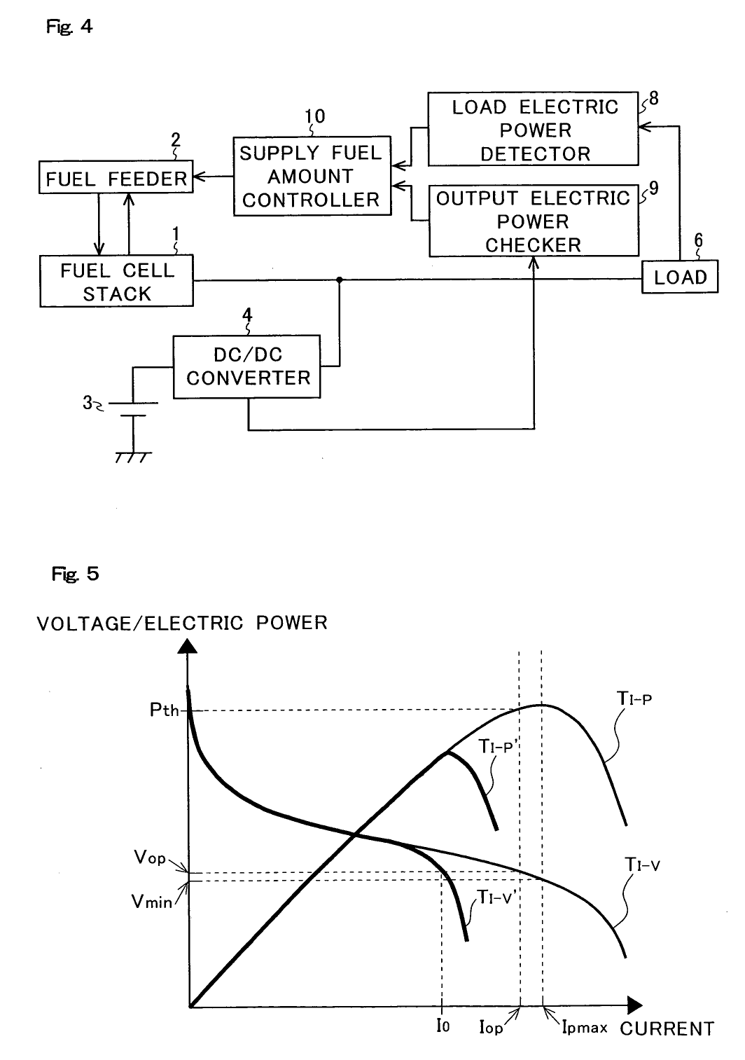

Still another example of the configuration of a fuel cell system embodying the present invention is shown in FIG. 4. In FIG. 4, such parts as are found also in FIG. 1 are identified with common reference numerals, and no detailed explanation thereof will be repeated. Moreover, in the fuel cell system shown in FIG. 4, as in the fuel cell system shown in FIG. 1, the set output value Vop of the DC/DC converter 4 is set equal to or larger than the value Vmin of the output voltage of the fuel cell stack 1 as obtained when it is outputting the maximum output electric power.

The current-to-voltage and current-to-power characteristics of the fuel cell stack 1 are shown in FIG. 5. In FIG. 5, such parts as are found also in FIG. 2 are identified with common reference symbols. Even though the fuel cell stack 1 is fed with a predetermined amount of fuel at regular time intervals, the density of fuel varies because of loss in collecting unused fuel, evaporation resulting from a rise in ambient temperature, and other factors. As the density of fuel becomes lower, the current-to-voltage and current-to-power characteristic curves of the fuel cell stack 1 shift as indicated by T_{I-V}′ and T_{I-P}′, respectively. That is, the electric power that can be extracted from the fuel cell stack 1 becomes less than designed. This state is called a shortage of fuel.

As compared with the fuel cell system shown in FIG. 1, the fuel cell system shown in FIG. 4 further comprises a load electric power detector 8, an output electric power checker 9, and a supply fuel amount controller 10.

The load electric power detector 8 detects the electric power (hereinafter the load electric power) required from the fuel cell system by the load 6, and feeds the result of the detection to the supply fuel amount controller 10. For example, in a case where the load 6 is a DC/DC converter, since the output voltage of the DC/DC converter is fixed at a predetermined set value, the load electric power detector 8 can detect the load electric power by detecting the output current of the DC/DC converter

The output electric power checker 9 checks whether or not electric power is being fed from the DC/DC converter 4 to the load 6, and feeds the result of the checking to the supply fuel amount controller 10. The output electric power checker 9 detects the input current or output current of the DC/DC converter 4. If the detected current is not zero, the output electric power checker 9 recognizes that electric power is being fed from the DC/DC converter 4, to the load 6; if the detected current is zero, the output electric power checker 9 recognizes that electric power is not being fed from the DC/DC converter 4 to the load 6.

If, despite the load electric power being lower than a threshold value Pth, electric power is being fed from the DC/DC converter 4 to the load 6, the supply fuel amount controller 10 recognizes that the fuel cell is short of fuel, and controls the fuel feeder 2 to make it feed fuel to the fuel cell stack 1 even at irregular time intervals. Here, in the range of current equal to or larger than I₀ but smaller than Iop, even when the load electric power is lower than the threshold value Pth, electric power is fed from the DC/DC converter 4 to the load 6. The lower the load electric power is at the moment that electric power starts to be fed from the DC/DC converter 4 to the load 6, the larger the amount of fuel is that the fuel cell is short of, and thus the larger the amount of fuel should preferably be made that the fuel cell is fed with.

As described above, if, despite the load electric power being lower than a threshold value Pth, electric power is being fed from the DC/DC converter 4 to the load 6, the supply fuel amount controller 10 recognizes that the fuel cell is short of fuel, and controls the fuel feeder 2 to make it feed fuel to the fuel cell stack 1 even at irregular time intervals. In this way, it is possible to overcome a shortage of fuel in the fuel cell.

Even in a fuel cell system provided with a blocking diode, it is possible to additionally provide a load electric power detector 8, an output electric power checker 9, and a supply fuel amount controller 10 as described above. This helps overcome a shortage of fuel in the fuel cell. From the viewpoint of enhancing the efficiency of the fuel cell system, however, it is preferable to adopt a configuration, as shown in FIG. 4, without a blocking diode.

With the fuel cell system shown in FIG. 4, unless the set output value Vop of the DC/DC converter 4 is set equal to or larger than the value Vmin of the output voltage of the fuel cell stack 1 as obtained when it is outputting the maximum output electric power, it is not possible to achieve the object of the present invention, that is, to eliminate the possibility of shortening the lifetime of a fuel cell. Even then, however, the additional provision of the load electric power detector 8, the output electric power checker 9, and the supply fuel amount controller 10 does help overcome a shortage of fuel in the fuel cell. It should therefore be understood that, in any fuel cell system, not limited to one configured as shown in FIG. 4, that is built as a system in which a fuel cell and an electric storage device are provided in parallel, additionally providing a load electric power detector 8, an output electric power checker 9, and a supply fuel amount controller 10 helps overcome a shortage of fuel in the fuel cell.

The present invention may be carried out in any manner other than specifically described above as embodiments; that is, when the present invention is carried out, within the scope and spirit thereof, many variations and modifications are possible. For example, the configurations shown in FIGS. 3 and 4 may be combined together to build a fuel cell system in which the set output value Vop of the DC/DC converter 4 is set equal to or larger than the value Vmin of the output voltage of the fuel cell stack 1 as obtained when it is outputting the maximum output electric power.

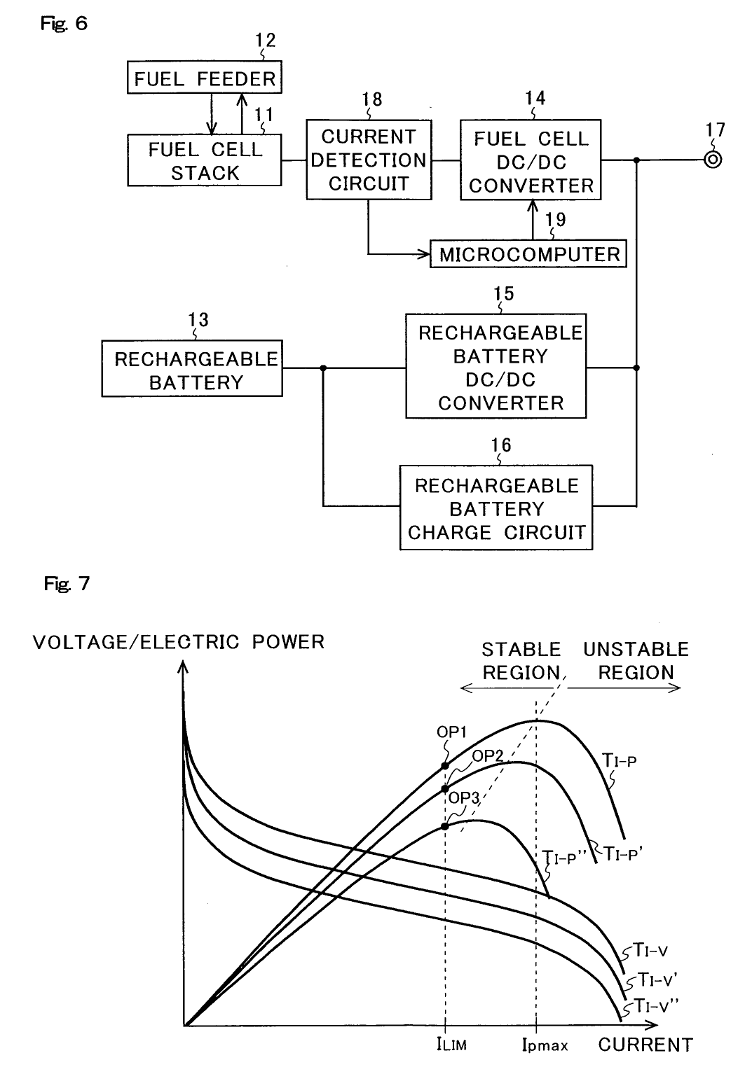

Next, an example of the configuration of a fuel cell system embodying the present invention, in a case where it is provided with a fuel cell DC/DC converter, is shown in FIG. 6.

The fuel cell system embodying the invention shown in FIG. 6 is built as a system in which a fuel cell and an electric storage device are provided in parallel, and comprises a fuel cell stack 11, a fuel feeder 12, a rechargeable battery 13 as an electric storage device, a fuel cell DC/DC converter 14, a rechargeable battery DC/DC converter 15, a rechargeable battery charge circuit 16, a system output terminal 17, a current detection circuit 18, and a microcomputer 19. The system output terminal 17 consists of a positive terminal and a negative terminal via which a direct-current output is fed out.

The fuel feeder 12 feeds the fuel cell stack 11 with a predetermined amount of fuel at regular time intervals, and collects from the fuel cell stack 11 the fuel that has remained unused therein. The fuel cell stack 11 is connected via the current detection circuit 18, which detects the output current of the fuel cell stack 11, to the input end of the fuel cell DC/DC converter 14, and the positive output end of the fuel cell DC/DC converter 14 is connected to the positive terminal of the system output terminal 17. The rechargeable battery 13 is connected to the input end of the rechargeable battery DC/DC converter 15 and to the output end of the rechargeable battery charge circuit 16, and the positive output end of the rechargeable battery DC/DC converter 15 and the positive input end of the rechargeable battery charge circuit 16 are both connected the positive terminal of the system output terminal 17. The negative output end of the fuel cell DC/DC converter 14, the negative output end of the rechargeable battery DC/DC converter 15, and the negative input terminal of the rechargeable battery charge circuit 16 are all connected to the negative terminal of the system output terminal 17. Based on the result of the detection by the current detection circuit 18, the microcomputer 19 controls the fuel cell DC/DC converter 14. In the fuel cell system embodying the invention shown in FIG. 6, the fuel feeder 12 operates from electric power derived from the output of the fuel cell system, and, at the start-up of the system, the fuel feeder 12 operates from electric power derived from the output of the rechargeable battery 13.

The system output terminal 17 is connected to the direct-current input terminal of an electric appliance (load), so that electric power is fed from the fuel cell system embodying the invention shown in FIG. 6 to the electric appliance.

The fuel cell DC/DC converter 14 steps up the direct-current voltage outputted from the fuel cell stack 11 to, in principle, a direct-current voltage of a predetermined value (PV1) and then outputs it. The rechargeable battery DC/DC converter 15 steps up the direct-current voltage outputted from the rechargeable battery 13 to a direct-current voltage of a predetermined value (PV2) and then outputs it. Here, the value (PV1) of the output voltage of the fuel cell DC/DC converter 14 is set larger than the value (PV2) of the output voltage of the rechargeable battery DC/DC converter 15. Thus, in principle, the output electric power of the fuel cell DC/DC converter 14 alone is fed via the system output terminal 17 to the electric appliance.

However, when, as a result of an increase in the electric power required by the electric appliance, the output current of the fuel cell stack 11 increases until it reaches a limit value I_{LIM}, the microcomputer 19 holds the step-up ratio of the fuel cell DC/DC converter 14 at a fixed value, with the result that the output voltage of the fuel cell DC/DC converter 14 drops down to the predetermined value (PV2). Thus, when the output current of the fuel cell stack 11 reaches the limit value I_{LIM}, the value of the output voltage of the fuel cell DC/DC converter 14 and the value of the output voltage of the rechargeable battery DC/DC converter 15 both become equal to the predetermined value (PV2). Now, both the output electric power of the fuel cell DC/DC converter 14 and the output electric power of the rechargeable battery DC/DC converter 15 are fed via the system output terminal 17 to the electric appliance, and the output current of the fuel cell stack 11 is clamped at the limit value I_{LIM}.

Here, the limit value I_{LIM} is set equal to or smaller than the value Ipmax (see FIG. 7) of the output current of the fuel cell stack 11 as observed when it is outputting the maximum output electric power in its initial state. Thus, the fuel cell stack 11 never operates in the range of current larger than Ipmax. This eliminates the possibility of shortening the lifetime of the fuel cell stack 11 in its initial state.

The fuel cell stack 11 tends to output an increasingly low output as its use duration increases. Thus, the fuel cell stack 11 has current-to-voltage and current-to-power characteristics as shown in FIG. 7. In FIG. 7, the symbols T_{I-V} and T_{I-P} indicates the current-to-voltage and current-to-power characteristic curves, respectively, of the fuel cell stack 11 in its initial state; the symbols T_{I-V}′ and T_{I-P}′ indicates the current-to-voltage and current-to-power characteristic curves, respectively, of the fuel cell stack 11 after “A” hours of use; and the symbols T_{I-V}″ and T_{I-P}″ indicates the current-to-voltage and current-to-power characteristic curves, respectively, of the fuel cell stack 11 after “B” (>“A”) hours of use.

Given the above-mentioned tendency of the fuel cell stack 11, for the fuel cell stack 11 to operate in a stable region all the time, it needs to operate in the stable region even at the end of its maximum use duration (that is, the set lifetime of the fuel cell system). To achieve this, the limit value I_{LIM} needs to be set equal to or smaller than the value of the output current of the fuel cell stack 11 as observed when it is outputting the maximum output electric power at the end of the maximum use duration. Consider, for example, a case where the maximum use duration is “B” hours and the limit value I_{LIM} is set as shown in FIG. 7. In this case, the operating points in the initial state, after “A” hours' use, and after “B” hours' use are located at OP1, OP2, and OP3, respectively. In this way, it is possible to let the fuel cell stack 11 operate in a stable region all the time. Here, however, attention should be paid to the following problem: when the limit value I_{LIM} is set equal to or smaller than the value of the output current of the fuel cell stack 11 as observed when it is outputting the maximum output electric power at the end of the maximum use duration, the fuel cell stack 11 cannot deliver its optimum performance in the initial state.

The rechargeable battery charge circuit 16 charges the rechargeable battery 13 by using the surplus electric power (which equals the output electric power of the fuel cell stack 11 minus the electric power consumed in the fuel cell system minus the electric power required by the electric appliance) available when the output electric power of the fuel cell stack 11 is higher than the electric power required by the electric appliance or, when the electric appliance as the load is not operating, the output electric power of the fuel cell stack 11.

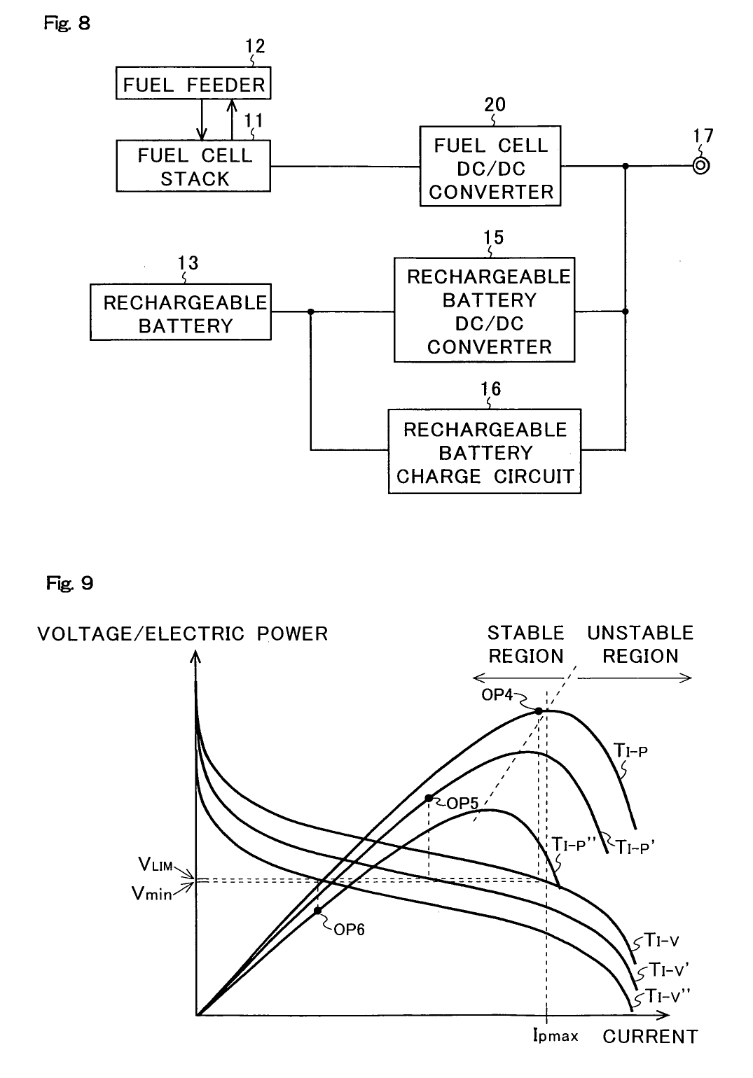

Next, another example of the configuration of a fuel cell system embodying the present invention, in a case where it is provided with a fuel cell DC/DC converter, is shown in FIG. 8 In FIG. 8, such parts as are found also in FIG. 6 are identified with common reference numerals, and no detailed explanation thereof will be repeated.

As compared with the fuel cell system embodying the present invention shown in FIG. 6, the fuel cell system embodying the present invention shown in FIG. 8 lacks the current detection circuit 18 and the microcomputer 19, and comprises, in place of the fuel cell DC/DC converter 14, a fuel cell DC/DC converter 20.

The fuel cell DC/DC converter 20 steps up the direct-current voltage outputted from the fuel cell stack 11 to, in principle, a direct-current voltage of a predetermined value (PV1) and then outputs it. Thus, in principle, the output electric power of the fuel cell DC/DC converter 20 alone is fed via the system output terminal 17 to the electric appliance.

Here, there is an upper limit to the step-up ratio of the fuel cell DC/DC converter 20. Thus, when, as a result of an increase in the electric power required by the electric appliance, the output voltage of the fuel cell stack 11 decreases until it reaches a limit value V_{LIM}, the step-up ratio of the fuel cell DC/DC converter 20 reaches its upper limit, with the result that the output voltage of the fuel cell DC/DC converter 20 drops down to a predetermined value (PV2). Now, both the output electric power of the fuel cell DC/DC converter 20 and the output electric power of the rechargeable battery DC/DC converter 15 are fed via the system output terminal 17 to the electric appliance, and the output voltage of the fuel cell stack 11 is clamped at the limit value V_{LIM}.

Here, the limit value V_{LIM} is set equal to or larger than the value Vmin (see FIG. 9) of the output voltage of the fuel cell stack 11 as observed when it is outputting the maximum output electric power in its initial state. Thus, the fuel cell stack 11 never operates in the rage of voltage lower than Vmin (that is, the range of current larger than Ipmax). This eliminates the possibility of shortening the lifetime of the fuel cell stack 11 in its initial state.

The fuel cell stack 11 tends to output an increasingly low output as its use duration increases. Thus, the fuel cell stack 11 has current-to-voltage and current-to-power characteristics as shown in FIG. 9. In FIG. 9, the symbols T_{I-V} and T_{I-P} indicates the current-to-voltage and current-to-power characteristic curves, respectively, of the fuel cell stack 11 in its initial state; the symbols T_{I-V}′ and T_{I-P}′ indicates the current-to-voltage and current-to-power characteristic curves, respectively, of the fuel cell stack 11 after “A” hours of use; and the symbols T_{I-V}″ and T_{I-P}″ indicates the current-to-voltage and current-to-power characteristic curves, respectively, of the fuel cell stack 11 after “B” (>“A”) hours of use.

Given the above-mentioned tendency of the fuel cell stack 11, for the fuel cell stack 11 to operate in a stable region all the time, it needs to operate in the stable region even in its initial state. To achieve this, the limit value V_{LIM} needs to be set equal to or larger than the value of the output voltage of the fuel cell stack 11 as observed when it is outputting the maximum output electric power in the initial state. Consider, for example, a case where the maximum use duration is “B” hours and the limit value V_{LIM} is set as shown in FIG. 9. In this case, the operating points in the initial state, after “A” hours' use, and after “B” hours' use are located at OP4, OP5, and OP6, respectively. In this way, it is possible to let the fuel cell stack 11 operate in a stable region all the time. Here, however, attention should be paid to the following problem: when the limit value V_{LIM} is set equal to or larger than the value of the output voltage of the fuel cell stack 11 as observed when it is outputting the maximum output electric power in the initial state, the output electric power of the fuel cell stack 11 decreases greatly as its use duration increases.

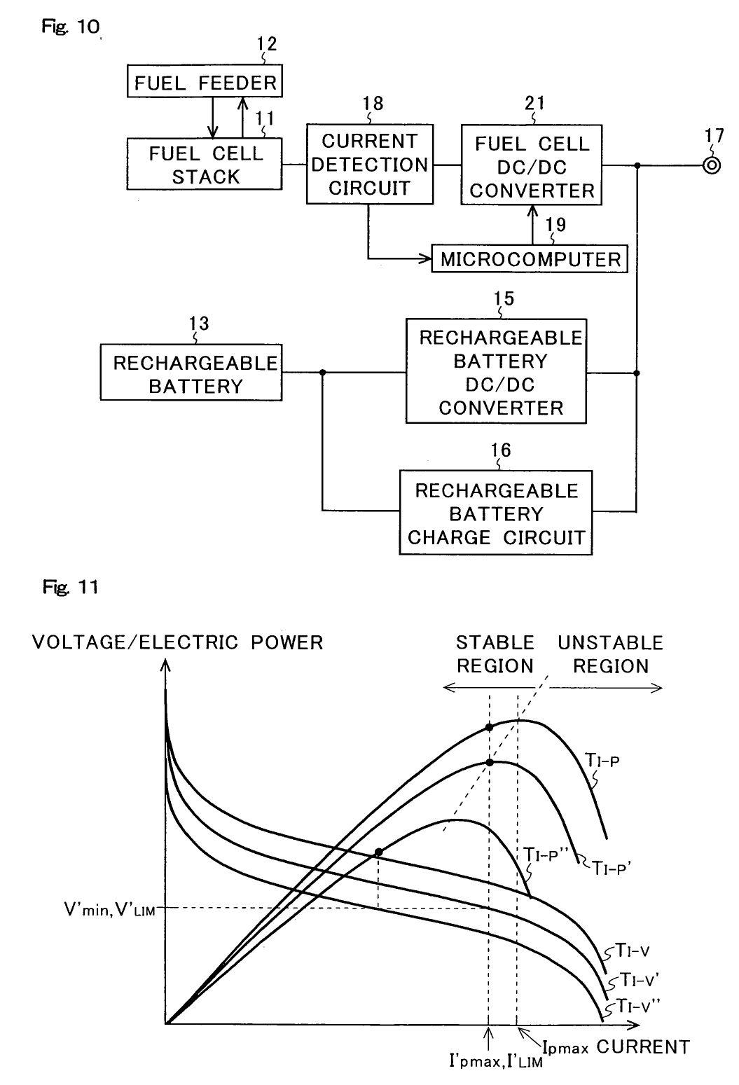

Next, still another example of the configuration of a fuel cell system embodying the present invention, in a case where it is provided with a fuel cell DC/DC converter, is shown in FIG. 10 In FIG. 10, such parts as are found also in FIG. 6 are identified with common reference numerals, and no detailed explanation thereof will be repeated.

The fuel cell stack 11 tends to output an increasingly low output as its use duration increases. Thus, the fuel cell stack 11 has current-to-voltage and current-to-power characteristics as shown in FIG. 11. In FIG. 11, the symbols T_{I-V} and T_{I-P} indicates the current-to-voltage and current-to-power characteristic curves, respectively, of the fuel cell stack 11 in its initial state; the symbols T_{I-V}′ and T_{I-P}′ indicates the current-to-voltage and current-to-power characteristic curves, respectively, of the fuel cell stack 11 after “A” hours of use; and the symbols T_{I-V}″ and T_{I-P}″ indicates the current-to-voltage and current-to-power characteristic curves, respectively, of the fuel cell stack 11 after “B” (>“A”) hours of use.

As compared with the fuel cell system embodying the present invention shown in FIG. 6, the fuel cell system embodying the present invention shown in FIG. 10 comprises, in place of the fuel cell DC/DC converter 14, a fuel cell DC/DC converter 21.

The fuel cell DC/DC converter 21 steps up the direct-current voltage outputted from the fuel cell stack 11 to, in principle, a direct-current voltage of a predetermined value (PV1) and then outputs it. Here, the value (PV1) of the output voltage of the fuel cell DC/DC converter 21 is set larger than the value (PV2) of the output voltage of the rechargeable battery DC/DC converter 15. Thus, in principle, the output electric power of the fuel cell DC/DC converter 21 alone is fed via the system output terminal 17 to the electric appliance.

However, when, as a result of an increase in the electric power required by the electric appliance, the output current of the fuel cell stack 11 increases until it reaches a limit value I′_{LIM}, the microcomputer 19 holds the step-up ratio of the fuel cell DC/DC converter 21 at a fixed value, with the result that the output voltage of the fuel cell DC/DC converter 21 drops down to the predetermined value (PV2). Thus, when the output current of the fuel cell stack 11 reaches the limit value I′_{LIM}, the value of the output voltage of the fuel cell DC/DC converter 21 and the value of the output voltage of the rechargeable battery DC/DC converter 15 both become equal to the predetermined value (PV2). Now, both the output electric power of the fuel cell DC/DC converter 21 and the output electric power of the rechargeable battery DC/DC converter 15 are fed via the system output terminal 17 to the electric appliance, and the output current of the fuel cell stack 11 is clamped at the limit value I′_{LIM}.

On the other hand, there is an upper limit to the step-up ratio of the fuel cell DC/DC converter 21. Thus, when, as a result of an increase in the electric power required by the electric appliance, the output voltage of the fuel cell stack 11 decreases until it reaches a limit value V′_{LIM}, the step-up ratio of the fuel cell DC/DC converter 21 reaches its upper limit, with the result that the output voltage of the fuel cell DC/DC converter 21 drops down to a predetermined value (PV2). Now, both the output electric power of the fuel cell DC/DC converter 21 and the output electric power of the rechargeable battery DC/DC converter 15 are fed via the system output terminal 17 to the electric appliance, and the output voltage of the fuel cell stack 11 is clamped at the limit value V_{LIM}.

Here, consider, for example, a case where the limit value I′_{LIM} is set equal to the value I′pmax of the output current of the fuel cell stack 11 as observed when it is outputting the maximum output electric power after having been used “A” hours, and where the limit value V′_{LIM} is set equal to the value V′min of the output voltage of the fuel cell stack 11 as observed when it is outputting the maximum output electric power after having been used “A” hours. In this case, while the use duration is equal to or less than “A” hours, the limit value I′_{LIM} prevents the fuel cell stack 11 from operating in the range of current larger than I′pmax. Thus, while the use duration is equal to or less than “A” hours, there is no possibility of shortening the lifetime of the fuel cell stack 11. On the other hand, while the use duration is more than “A” hours, the limit value V′_{LIM} prevents the fuel cell stack 11 from operating in the range of voltage lower than V′min. Thus, while the use duration is more than “A” hours, there is no possibility of shortening the lifetime of the fuel cell stack 11.

Thanks to the fuel cell DC/DC converter 21 operating as described above, with the fuel cell system embodying the present invention shown in FIG. 10, it is possible to extract sufficient electric power from the fuel cell stack 11 even in its initial state, and it is possible to prevent significant lowering of the output electric power of the fuel cell stack 11 even after a long duration of use.

In the fuel cell system embodying the present invention shown in FIG. 6, the microcomputer 19 may be additionally provided with a capability to measure the use duration of the fuel cell system. In that case, by decreasing the limit value I_{LIM} as the use duration increases in such a way that, at any given time during the use duration, the limit value I_{LIM} is equal to or smaller than the value of the output current of the fuel cell stack 11 as observed when it is outputting the maximum output electric power, it is possible to achieve effects similar to those achieved with the fuel cell system embodying the present invention shown in FIG. 10.

Likewise, in the fuel cell system embodying the present invention shown in FIG. 8, the fuel cell DC/DC converter 20 may be additionally provided with a capability to measure the use duration of the fuel cell system. In that case, by increasing the upper limit of the step-up ratio and decreasing the limit value V_{LIM} as the use duration increases in such a way that, at any given time during the use duration, the limit value V_{LIM} is equal to or larger than the value of the output voltage of the fuel cell stack 11 as observed when it is outputting the maximum output electric power, it is possible to achieve effects similar to those achieved with the fuel cell system embodying the present invention shown in FIG. 10.

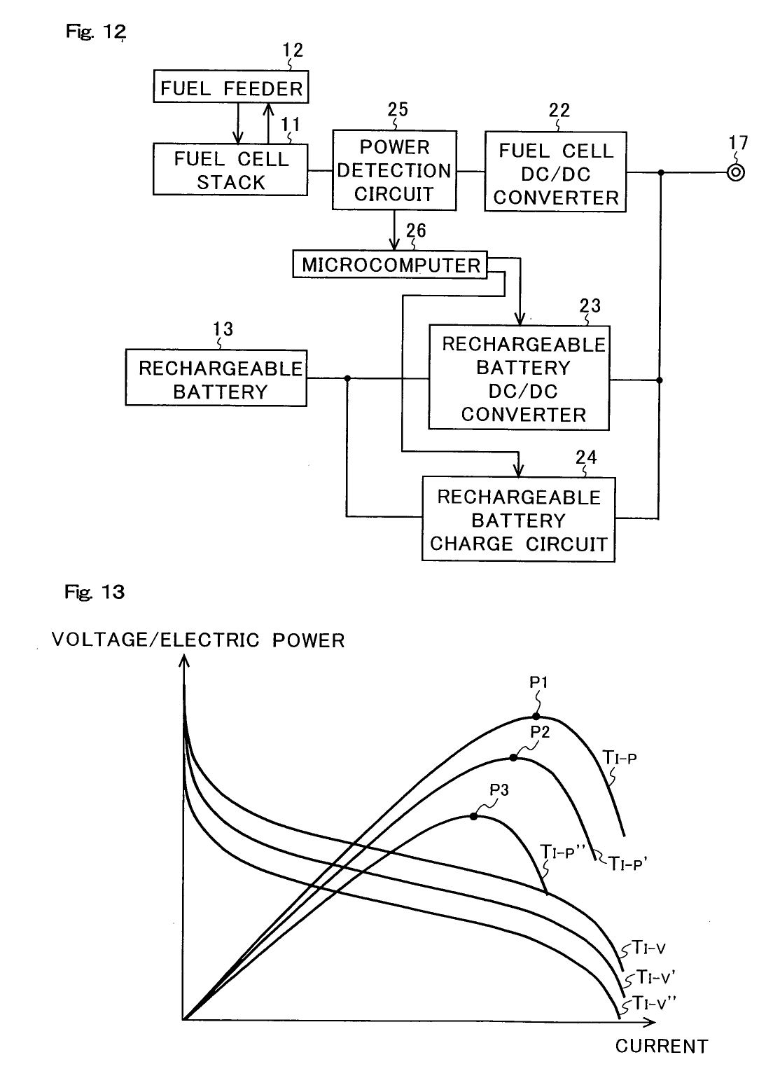

Next, a further example of the configuration of a fuel cell system embodying the present invention, in a case where it is provided with a fuel cell DC/DC converter, is shown in FIG. 12. In FIG. 12, such parts as are found also in FIG. 6 are identified with common reference numerals, and no detailed explanation thereof will be repeated.

As compared with the fuel cell system embodying the present invention shown in FIG. 6, the fuel cell system embodying the present invention shown in FIG. 12 comprises, in place of the fuel cell DC/DC converter 14, the rechargeable battery DC/DC converter 15, the rechargeable battery charge circuit 16, the current detection circuit 18, and the microcomputer 19, a fuel cell DC/DC converter 22, a rechargeable battery DC/DC converter 23, a rechargeable battery charge circuit 24, a power detection circuit 25, and a microcomputer 26, respectively.

The fuel cell DC/DC converter 22 steps up the direct-current voltage outputted from the fuel cell stack 11 to a direct-current voltage of a predetermined value (PV) and then outputs it. The rechargeable battery DC/DC converter 23 steps up the direct-current voltage outputted from the rechargeable battery 13 to a direct-current voltage of a predetermined value (PV) and then outputs it so that electric power of which the value (power value) is specified by the microcomputer 26 is delivered to the system output terminal 17. The rechargeable battery charge circuit 24 charges the rechargeable battery 13 with current of which the value (current value) is specified by the microcomputer 26. The power detection circuit 25 detects the output electric power of the fuel cell stack 11, and feeds the result of the detection to the microcomputer 26.

The microcomputer 26 controls the rechargeable battery DC/DC converter 23 and the rechargeable battery charge circuit 24 in such a way that the fuel cell stack 11 operates at the peak power point all the time. An example of the peak power point is shown in FIG. 13. In FIG. 13, such parts as are found also in FIG. 7 are identified with common reference symbols, and no detailed explanation thereof will be repeated. In FIG. 13, the symbols P1 to P3 indicate different peak power points. Through the above-described control performed by the microcomputer 26, even when the fuel cell stack 11 become short of fuel, or even when the output of the fuel cell stack 11 lowers as the use duration increases, it is possible to let the fuel cell stack 11 deliver its optimum performance, and it is possible to eliminate the possibility of shortening the lifetime of the fuel cell stack 11.

Now, an example of the operation of the microcomputer 26 will be described. The microcomputer 26, while gradually increasing the current value that it specifies to the rechargeable battery charge circuit 24, monitors the output electric power of the fuel cell stack 11 to check whether or not it is increasing as the current value increases. As soon as the output electric power of the fuel cell stack 11 stops increasing and starts to decrease, the microcomputer 26 sets the current value back to its value immediately before the change from increase to decrease, and stores the output electric power of the fuel cell stack 11 at the moment in an internal memory. In this way, the output electric power of the fuel cell stack 11 at the peak power point is stored in the internal memory of the microcomputer 26.

This operation for storing the output electric power of the fuel cell stack 11 at the peak power point the microcomputer 26 performs all the time or at regular time intervals so that the output electric power of the fuel cell stack 11 at the peak power point is updated at regular time intervals.

When the fuel cell system embodying the present invention shown in FIG. 12 is feeding electric power to the electric appliance connected to the system output terminal 17, the microcomputer 26 operates in the following manner. The microcomputer 26 calculates the maximum load-suppliable power by subtracting the electric power consumed in the fuel cell system (the electric power required for the fuel feeder 12 to operate, etc.) from the output electric power of the fuel cell stack 11 at the peak power point as stored in the memory. The microcomputer 26 then checks whether or not the load electric power is higher than the maximum load-suppliable power.

If the load electric power is equal to or lower than the maximum load-suppliable power, the microcomputer 26 controls the current value that it specifies to the rechargeable battery charge circuit 24 in such a way that the rechargeable battery 13 is charged with electric power of which the value equals the maximum load-suppliable power minus the load electric power. Moreover, if the load electric power is equal to or lower than the maximum load-suppliable power, the microcomputer 26 inhibits electric power from being fed from the rechargeable battery DC/DC converter 23 to the system output terminal 17.

By contrast, if the load electric power is higher than the maximum load-suppliable power, the microcomputer 26 makes the rechargeable battery DC/DC converter 23 output electric power of which the value equals the load electric power minus the maximum load-suppliable power. Moreover, if the load electric power is higher than the maximum load-suppliable power, the microcomputer 26 turns to zero the charge current of the rechargeable battery charge circuit 24.

In the example of operation described above, the microcomputer 26 detects the load electric power and determines the value at which the rechargeable battery DC/DC converter 23 is made to discharge and the value at which the rechargeable battery charge circuit 24 is made to charge. This permits the fuel cell stack 11 to follow the peak power point with good response. Incidentally, the microcomputer 26, even without detecting the load electric power, can control the rechargeable battery DC/DC converter 23 and the rechargeable battery charge circuit 24 in such a way that the fuel cell stack 11 operates at the peak power point all the time. Thus, so long as the fuel cell stack 11 follows the peak power point with good response, there is no need to detect the load electric power.

The embodiments described above all deal with cases in which a rechargeable battery (the rechargeable battery 3 or 13) is used as an electric storage device; it is however also possible to use, in place of the rechargeable battery, any other type of electric storage device (for example, an electrical double layer capacitor).

It should be noted that the current-to-voltage and current-to-power characteristics of the fuel cell stack shown FIGS. 2, 5, 7, 9, 11, 13, and 15 are all those observed when it is in a “stably operating state”, that is, in a state other than that in which it is immediately after the start-up of the fuel cell.

What is claimed is:

1. A fuel cell system built as a system in which a fuel cell and an electric storage device are provided in parallel, the fuel cell system comprising:
the fuel cell;
a fuel feeder;
the electric storage device; and
a DC/DC converter,
wherein the fuel feeder feeds the fuel cell with fuel,
wherein the DC/DC converter converts an output voltage of the electric storage device into a predetermined voltage and then outputs the predetermined voltage, and
wherein the predetermined voltage is equal to or higher than an output voltage of the fuel cell as obtained when the fuel cell is outputting a maximum output electric power.

2. The fuel cell system of claim 1,
wherein the fuel feeder feeds the fuel cell with a predetermined amount of fuel at regular time intervals, and collects, from the fuel cell, fuel that has remained unused therein.

3. The fuel cell system of claim 1,
wherein the fuel feeder operates from electric power derived from an output of the fuel cell system.

4. The fuel cell system of claim 1,
wherein an output end of the fuel cell and the DC/DC converter are directly connected together.

5. The fuel cell system of claim 1, further comprising:
an on/off control circuit,
wherein the on/off control circuit turns operation of the DC/DC converter on and off, and
wherein the on/off control circuit, when the output voltage of the fuel cell is higher than a predetermined value, turns the operation of the DC/DC converter off and, when the output voltage of the fuel cell is not higher than the predetermined value, turns the operation of the DC/DC converter on.

6. The fuel cell system of claim 1, further comprising:
a load electric power detector;
an output electric power checker; and
a supply fuel amount controller,
wherein the load electric power detector detects, as a load electric power, electric power that an external load requires from the fuel cell system,
wherein the output electric power checker checks whether or not electric power is being fed from the DC/DC converter to the external load, and
wherein the supply fuel amount controller receives a result of detection by the load electric power detector and a result of checking by the output electric power checker so that, if electric power is being fed from the DC/DC converter to the external load when the load electric power is lower than a threshold value, the supply fuel amount controller controls the fuel feeder to make the fuel feeder feed the fuel cell with fuel.

7. The fuel cell system of claim 1,
wherein the electric storage device is a rechargeable battery.

8. A fuel cell system built as a system in which a fuel cell and an electric storage device are provided in parallel, the fuel cell system comprising:
the fuel cell;
the electric storage device; and
a fuel cell current limiter,
wherein the fuel cell current limiter controls an output current of the fuel cell at a limit value or below, and
wherein the limit value is equal to or smaller than a value of the output current of the fuel cell as obtained when the fuel cell is outputting a maximum output electric power in a stably operating state after having been used in the stably operating state for a predetermined duration until an output of the fuel cell exhibits a drop as compared with the output in an initial state.

9. A fuel cell system built as a system in which a fuel cell and an electric storage device are provided in parallel, the fuel cell system comprising:
the fuel cell;
the electric storage device; and
a fuel cell voltage limiter,
wherein the fuel cell voltage limiter controls an output voltage of the fuel cell at a limit value or above, and
wherein the limit value is equal to or larger than a value of the output voltage of the fuel cell as obtained when the fuel cell is outputting a maximum output electric power in a stably operating state.

10. A fuel cell system built as a system in which a fuel cell and an electric storage device are provided in parallel, the fuel cell system comprising:
the fuel cell;
the electric storage device;
a fuel cell current limiter; and
a fuel cell voltage limiter,
wherein the fuel cell current limiter controls an output current of the fuel cell at a first limit value or below,
wherein the fuel cell voltage limiter controls an output voltage of the fuel cell at a second limit value or above,
wherein the first limit value is equal to or smaller than a value of the output current of the fuel cell as obtained when the fuel cell is outputting a maximum output electric power in a stably operating state after having been used in the stably operating state for a predetermined duration until an output of the fuel cell exhibits a drop as compared with the output in an initial state, and
wherein the second limit value is equal to or larger than a value of the output voltage of the fuel cell as obtained when the fuel cell is outputting the maximum output electric power in the stably operating state.

11. A fuel cell system built as a system in which a fuel cell and an electric storage device are provided in parallel, the fuel cell system comprising:
the fuel cell;
the electric storage device;
a DC/DC converter;
a charge circuit; and
a controller,
wherein the DC/DC converter converts an output voltage of the electric storage device;
wherein the charge circuit charges the electric storage device by using an output of the fuel cell, and
wherein the controller controls electric power passed through the DC/DC converter and through the charge circuit in such a way that the fuel cell operates at a maximum output electric power operating point thereof.
